(19) United States
(12) Patent Application Publication
(10) Pub. No.: US 2007/0020582 A1
(43) Pub. Date: Jan. 25, 2007

(54) Abutment for a dental implant, dental implant comprising such an abutment, and method for the production of dentures by means of said dental implant

(76) Inventor: Stefan Neumeyer, ESCHLKAM (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/538,718

(22) PCT Filed: Dec. 12, 2003
(86) PCT No.: PCT/DE03/04117

§ 371 Date: Sep. 28, 2006

(30) Foreign Application Priority Data
Dec. 13, 2002 (DE) 102 58 691.8
Feb. 5, 2003 (DE) 103 04 802.2

(51) Int. Cl. A61C 8/00

(52) U.S. Cl. 433/173

(57) ABSTRACT

The invention relates to a novel embodiment of a dental implant comprising a root section or root shaft that can be anchored within a jaw preferably by screwing, and a cap which is made of a solid material and can be fixed onto a coronal area of the shaft by means of an adhesive bond.

### BACKGROUND OF THE INVENTION

The present invention relates to an abutment and especially to a tooth implant and an abutment for the use with a tooth implant.

It is an object of the invention to provide for a tooth implant with which it is possible to fabricate a high-quality dental prosthesis at reduced expenditure of labor.

### SUMMARY OF THE INVENTION

A characteristic feature of one embodiment of the invention is, for example, the fact that the respective abutment of the implant, the implant consisting of at least this abutment and a shaft, is part of at least one abutment set, which consists of a plurality of different abutments, the form of which is adapted respectively to the form of a natural tooth. In the manufacture of the dental prosthesis, an abutment is selected from the abutment set with a form that most nearly corresponds to the tooth to be reconstructed using the implant. The further structure can then be provided either directly on the selected abutment or after preparation of the abutment.

“Structure” as used in reference to the invention means, for example, a shell attached to the abutment, e.g. a burned-on shell made of ceramic, which then forms the outer surface of a crown formed by the abutment. Structure in the context of the invention can also refer to separately manufactured elements of a dental prosthesis, which are then fixed to the abutment, which serves as a base. Such separately manufactured elements are, for example, bridge elements, telescopes, bars or separately manufactured shells or caps for crowns, etc. The abutments used are, for example, of a size that allows them to be prepared for adaptation to the individual form.

In another embodiment of the invention, the abutments are manufactured corresponding to the individual tooth form, for example using axis models or graphic technology or computer-supported processes, with which the respective abutment is fabricated individually corresponding to the form of the tooth to be replaced or restored.

“Corresponding to the natural form of the tooth” means forming the abutment of the respective abutment set based on the natural form of the tooth. “Individual form of the tooth” is the actual form of the tooth to be restored or the tooth crown to be restored, and especially matching the remaining existing teeth of a patient.

The major advantage of these new, individual anatomic abutments consists in the fact that they are designed corresponding to the natural teeth and enable treatment of a manner that is familiar to both the dentist and the dental technician from their experience with natural teeth and their restoration.

These individual anatomic and physiologically designed abutments consist of essentially three forms, corresponding to the functional tooth groups, which are derived from the front teeth, the premolars and the molars in the upper and lower jaw.

Therefore, they are reduced individual tooth forms such as those found by the dentist after grinding of the natural teeth or by the dental technician after making an impression. Differences in all three form groups consist in the framework of the tooth forms, whereby optimization of each individual tooth form or form group is possible through different dimensioning of the individual abutment sections, of the profiles, of the diameters, of the heights, of the shape due to rounding of transitions, of the edge design, of convexities and concavities, of the parallel or diverging or converging structures and forms.

Based on a natural tooth therefore, the abutments are preferably constructed so that starting from the abutment-implant composite or connecting surface (v) or the base of the abutment, which is typically garland-shaped, the abutment first has a certain base height or stage height (SH) in which the outer surfaces of the abutment extend preferably diverging outward into the approximal space or into the labial-buccal-palatinal-lingual soft tissue environment.

Thereby, in certain cases, a parallel or converging modification of the form of this abutment area may be advantageous.

This base element then passes by means of or via a sharp-edged or rounded horizontal or slanted, or channel-like stage of a differing depth into the actual body or corpus, which is designed similar to a preparation stump and predominantly slightly converging in coronal direction, with a primarily flat, or slightly concave or slightly convex body structure with a rounded diameter and which is designed corresponding to the basic form of the tooth to be replaced or a preparation model of the respective tooth. The abutment body then passes via rounded edges into the coronal tip area or chewing area. Corresponding to the form of the natural teeth, front tooth abutments in the buccal area preferably have a tip that is rounded in all directions with differing curvature radiuses in mesial-distal and labio/lingual-palatinal regions. Corresponding to the natural form, this passes in lingual-palatinal direction preferably concavely into a projection resulting from the Tuberculum dentis based on the physiological anatomical form of a front tooth and then passes over into the circular stage, which preferably has a typical garland-shaped course.

There are minor differences in the embodiments with respect to the use of the abutment for lower jaw front teeth or canine teeth or side incisors in the upper jaw. This concerns primarily the diameter in labial, lingual and palatinal and also in mesial-distal direction, which can possibly also be fixed. Smaller teeth, such as the lower incisors, have an oblong oval profile at the height of the passage of the structure from the soft tissue. Canines and upper middle incisors have a somewhat round oval profile, sometimes with distal convexities.

For premolars and molars, due to the natural form of the teeth, the chewing surface is provided with two, three, four or five cusps, which meet with each other with their own concave or convex or straight shape by means of saddles or v-shaped notches of various angles and with and without rounding of the transitions and edges.

In the buccal/palatinal view the premolar likewise has a single-cusp form, which based on or passing from the basic/stage ends in a rounded tip after the body or corpus.

From the side view a premolar is characterized by the existence of a buccal and lingual-palatinal cusp.

The cusps and the surface transitions and the tips are preferably rounded and the flanks preferably have a convex form. A concave or straight form is also possible.

Corresponding to this characterization, premolars have two cusps, which are preferably of the same height for teeth of the upper jaw, for example, but can also be of different heights. For premolars of the lower jaw, however, the buccal cusp is usually higher than the lingual cusp.

As opposed to the premolar caps, molar caps in the upper jaw have four cusps and those in the lower jaw have up to five cusps. At the same time, upper jaw molar abutments have a trapezoid or rounded square shape at the height of the soft tissue. Lower jaw molar abutments have an essentially rectangular profile, whereby the transitions of the edges are strongly rounded.

For upper jaw molars, there are preferably either four or three cusps, whereby the mesio-palatinal cusp can be the larger of all four and the disto-palatinal cusp is optional (3-cusp variant).

In the lower jaw there are four or five cusps, whereby in the five-cusp variant the disto-buccal cusp is smaller.

Alternatively, it is possible that the caps have a rounded square or strongly rounded profile, since the individual form of the teeth can be achieved very quickly by means of additional burning measures, e.g. ceramic.

The caps are made of strong or high-strength material, e.g. zircon oxide or aluminum oxide or of sintered metals, whereby preferably only one material is used due to visual and physical strength requirements.

This individual form enables the dentist or dental technician to treat implants or structures as natural teeth, using known work processes without additional expenditure of time, as in the treatment of natural teeth.

At the same time it is possible to optimally use all materials that have been developed for the treatment or preparation of natural teeth, such as ceramic, as is the case with natural teeth. This is relevant not only for aesthetic reasons but also for the physiological criteria of strength and considerably enhances the endurance of the treatment, e.g. of a crown, and of the implant.

### BRIEF DESCRIPTION OF THE DRAWINGS

The invention is described below in more detail based on exemplary embodiments with reference to the drawings, in which:

FIG. 1 shows a simplified representation of an implant according to the invention with an abutment embodied as a prepared cap;

FIG. 2 shows the implant of FIG. 1 with a prepared cap and with a shell made of ceramic burned onto the cap;

FIG. 3 shows a depiction similar to FIG. 2, however of a further possible embodiment;

FIG. 4 shows various possible stage forms of caps adapted to the natural tooth form for the implant of FIG. 1;

FIG. 5 shows a simplified depiction in top view of a cap according to the invention;

FIG. 6-9 show different forms of caps according to the invention;

FIG. 10 shows a simplified depiction of a cap for a front tooth in labial view;

FIG. 11 shows the cap of FIG. 10 in side view;

FIG. 12 shows the cap corresponding to a premolar in buccal/palatinal or lingual view;

FIG. 13 shows the cap of FIG. 12 in side view;

FIG. 14 shows a cap similar to a molar in buccal/palatinal or lingual view;

FIG. 15 shows the cap of FIG. 14 in side view, from mesial and distal;

FIG. 16 shows a simplified depiction of a further possible embodiment of the invention;

FIG. 17 shows an implant according to the invention with a compensating cap;

FIG. 18 shows a cross section of an upper jaw bone with an implant and with a cap with an axis compensating angle;

FIG. 19 shows a simplified cross-section view of the cap of FIG. 18, together with a similar cap without an axis compensating angle;

FIG. 20-21 show two further possible embodiments of an abutment designed as a cap; and

FIG. 22 shows a simplified cross-section view of a cap according to the invention.

### DETAILED DESCRIPTION OF THE INVENTION

In the drawings, 1 generally refers to a tooth implant that can be anchored in the jaw of a patient by being screwed in. For this purpose, the implant 1 has a root section or shaft 2 provided with threads and made of a suitable material, for example titanium. In the coronal area the shaft 2 is provided with a bar 3 designed as a retention bar, which serves to fasten a cap 4 by means of an adhesive bond.

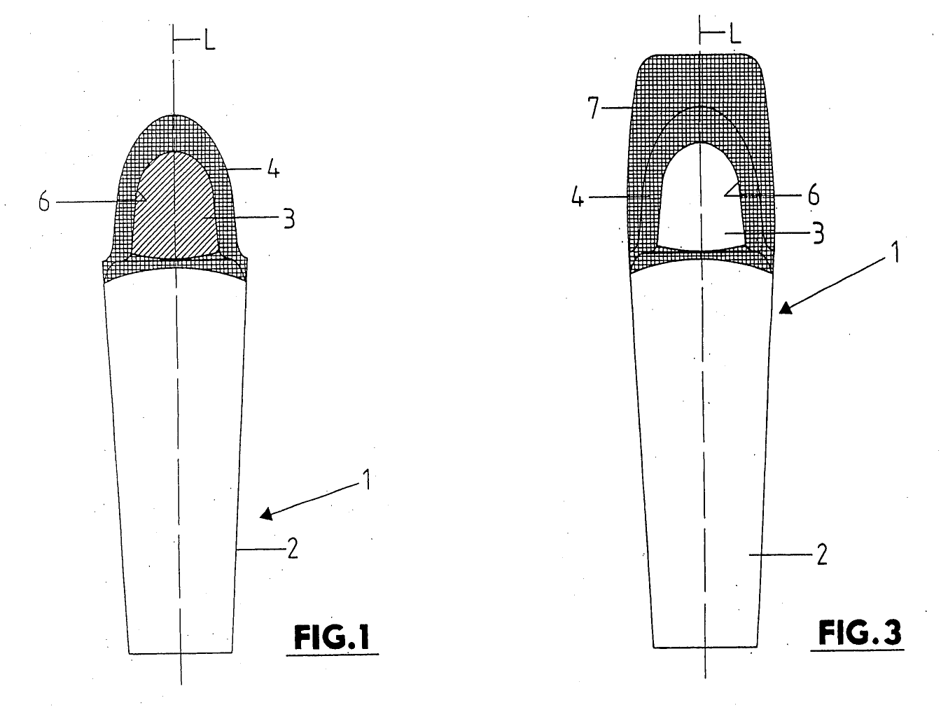

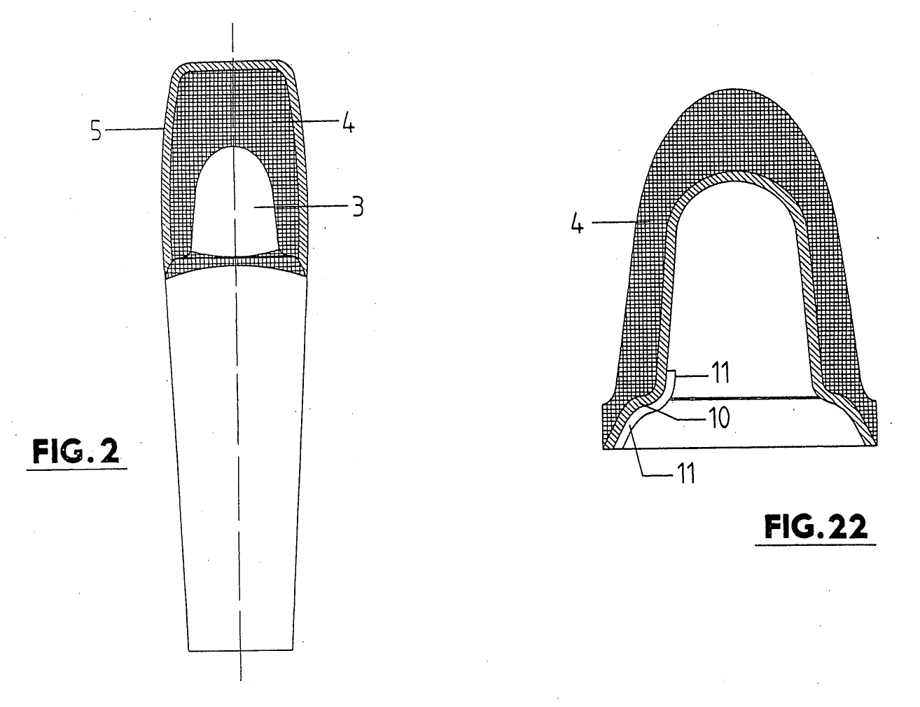

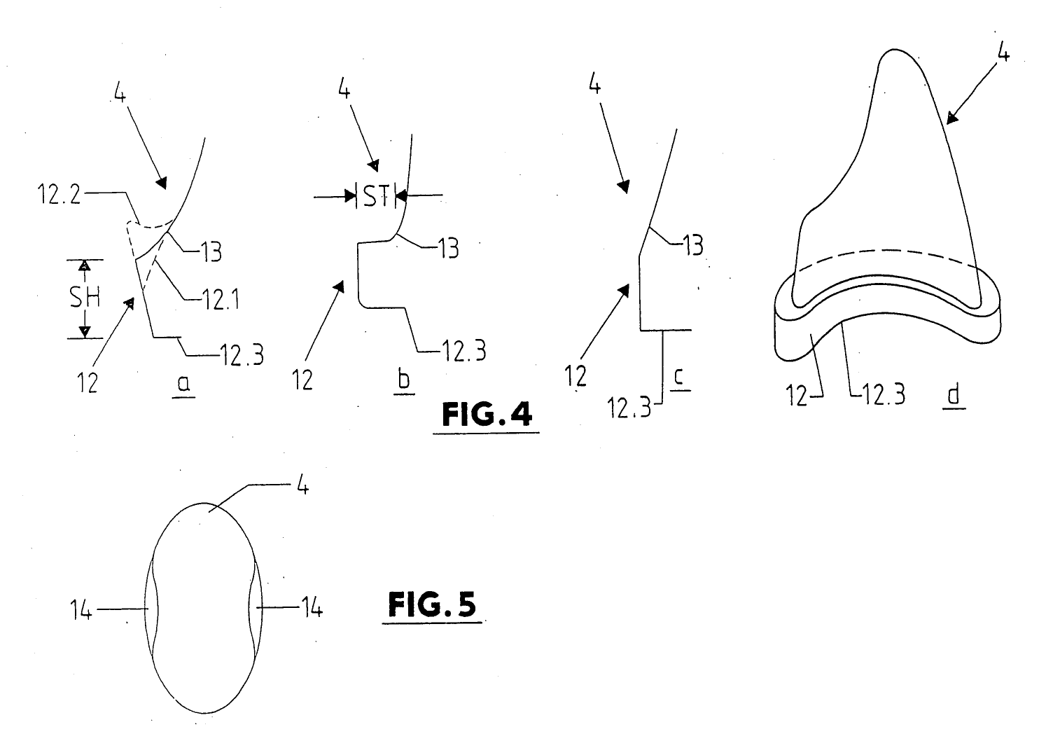

In the embodiment depicted in FIGS. 1-3 the cap 4 is made of a high-strength material that can nevertheless be prepared using the usual dental tools, for example of zircon oxide or aluminum oxide.

The prepared cap 4 forms, for example, the base of a crone, i.e. a shell 5 made of ceramic forming the outer surface of the crown is burned onto the prepared cap 4. Furthermore, it is possible to use the prepared cap 4 as the base for another element of a dental prosthesis, for example as the base for a structure, such as for a bridge or a bridge element, or for a bar or telescope, etc.

The connection between the cap 4 and the implant 1 is achieved in the depicted embodiment preferably only by gluing or cementing. This ensures that through the bar 3 and the recess 6 receiving this bar and adapted to the form of the bar 3, the bond between the cap 4 and the implant 1 covers a large area and also this adhesive bond and its strength are at least essentially independent of the form of the prepared cap 4 and of the degree of preparation of the cap 4.

The use of the implant 1 and of the corresponding cap 4 is e.g. such that first the implant 1 is anchored in the jaw of the patient by being screwed in, in particular such that the bar 3 is accessible after the healing phase. Afterwards, the usual technology is used for example to make an impression of the upper or lower jaw of the patient and then using this impression and the cap 4 taken with the impression for manufacturing a dental prosthesis, for example a crown, which corresponds to the form of the tooth to be reconstructed. For this purpose, if necessary, the cap can be prepared in the dental lab and then the shell 5 made of ceramic forming the outer surface of the crown can be burned onto the cap or another structure can be manufactured as a suitable base for the prepared cap 4. The dental prosthesis thus manufactured in the dental lab is then placed on the bar 3 of the healed shaft 2 and fixed there by means of adhesive or cement. The cap 4 thereby overlaps the coronal area of the implant and especially also the conical bar 3 in order to achieve a very strong bond.

Generally it is also possible to fasten the cap 4 on the bar 3 after healing of the shaft, then to prepare the cap 4 after hardening of the glue on the patient, so that the cap is used in the usual manner as a prepared tooth stump. The connection of the prepared cap 4 with a further, separately manufactured structure is performed with the usual methods, for example using a suitable adhesive or a suitable plastic cement or cement.

Independent of the methods described above for the use of the implant according to the invention, a special feature of the invention is that the caps 4 are already manufactured based on the natural tooth form, in order to reduce the general expenditure of labor, also for preparing or prepping.

In a first possible embodiment, caps are provided for the form or shape of which are adapted to the individual tooth forms.

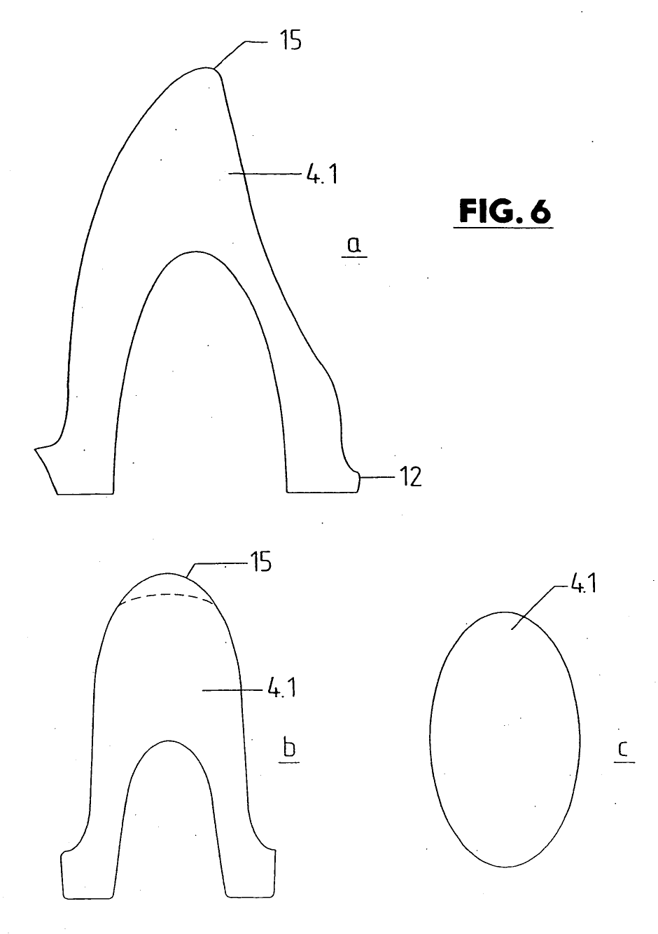

As indicated in FIG. 1, the respective cap 4 is designed outside with a stage 12 with a base on its side facing the root section or shaft, which (base) just as the base corresponding to the position d of FIG. 4 is garland-shaped, i.e. multi-convex, extends on the axis of the cap and corresponding to positions a-c of FIG. 4 can exhibit a wide variety of shapes, independent of the further shape of the cap 4. In position a, the transition of the stage 12 to the shell surface of the cap 4 has a channel shape and in position b a rectangular shape, while this transition 13 in position c is designed as a slanted surface. The stage itself can also have different forms, for example conical inward, circular or conical outward, etc. Furthermore, the height, designated LH in this drawing, of the respective stage 12 can vary for the caps 4. Furthermore, the stage, as indicated in 12.1, can be rounded or, as indicated in 12.2, slanted and convex. The same applies by analogy for the stage depth ST, i.e. for the radial distance of the outer surface of the stage 12 from the shell surface of the cap 4. This stage depth ST is at least 0.1 to 0.2 mm, preferably 0.5 mm. The bottom of the cap 4 or its base is designated 12.3.

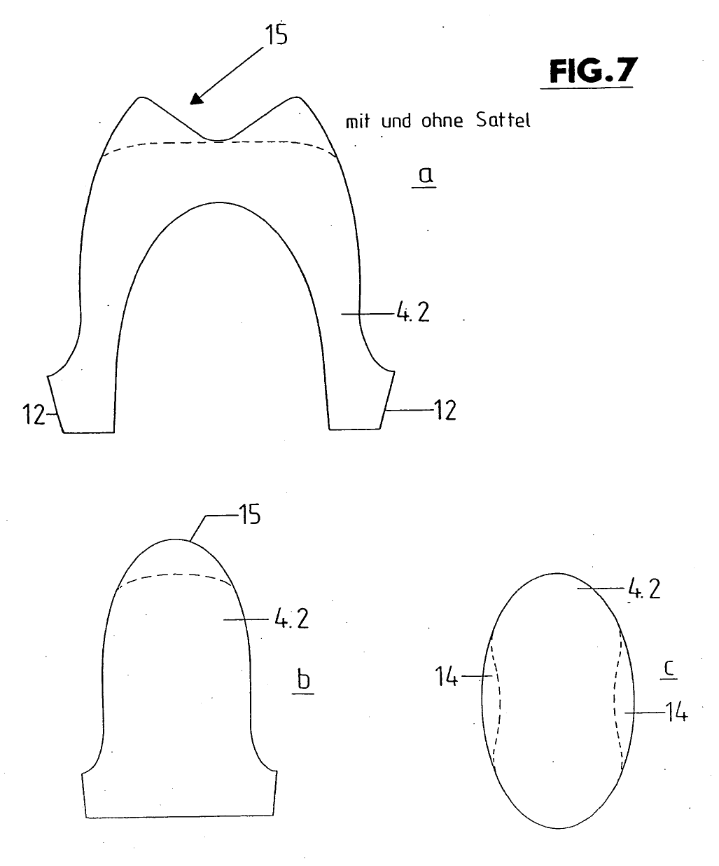

FIG. 5 again shows the general form of the cap 4 in a view of this cap from above. As depicted in this drawing, the cap 4 has an indentation or a recess on each of two sides that are offset against each other in mesio-distal direction, i.e. on two adjacent sides in the row of teeth when the cap is in place.

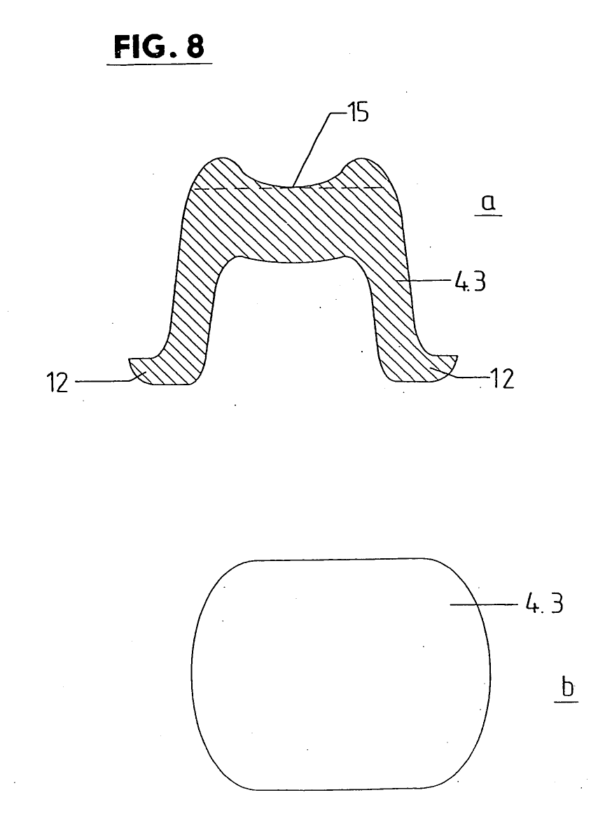

The following FIGS. 6-9 show examples of different caps that are adapted to the natural tooth form, each in side view and front view (cross-section) and some in top view.

FIG. 6 shows a cap 4.1 that is suitable for incisors. Viewed from the side, this cap 4.1 has a flame-shaped outer contour and accordingly is first curved concavely starting from the top on the palatinal lingual side and then formed convexly before the cap passes over into the area forming the stage or step. On the labial side the cap is curved slightly convexly or is straight.

Viewed from the front, the cap has the form shown in position b, i.e. it has parallel walls on both side flanks or is slightly convex and widens from the tip to the stage or step 12. On the tip 15, the cap 4 a can be flat or straight or, as indicated by dotted lines, convex. The cap 4 a is especially suitable for use in the area of the incisors and canines.

FIG. 7 shows in positions a-c in side view, front view and top view a cap 4.2 with a form adapted to the natural form of the premolars. Starting from the top 15, at which the cap 4.2 has two cusps, which are set off against each other in bucco-oral direction and are separated by a saddle-like depression, the cap is curved and rounded on the entire outer surface and then passes over into the stage 12 either progressively or with a concave rounded or rectangular transition 13. As indicated in position b with dotted lines, the cap can also be flat or essentially flat on its top side. In top view (position c) the cap 4.2 has an oval or oblong design, with the shorter cross-sectional side in mesio-distal direction. On both opposing sides the cap 4.2 can be provided with a recess 14.

FIG. 8 shows in position a and b in side view, also in front view and in top view, a cap 4.3 that is adapted to the natural form of a molar. On the top, the cap has four cusps, which are offset against each other in mesio-distal and in bucco-oral direction. On the peripheral sides of the cap 4.3 with an essentially rectangular design with rounded corners as viewed from the top, the diameter increases starting from the top 15 of the cap to the stage 12 or to the transition 13, in a slightly convex manner.

FIG. 9 shows in the positions a1 and a2 in buccal and palatinal view and in the positions b1 and b2 in top view a cap 4.4, which is adapted to the anatomic form of an upper jaw molar.

Furthermore, the caps are each designed to fit a corresponding shaft 2. The shaft 2 has a different diameter for the incisors, canines, premolars and molars, whereby the diameter varies from 3.0 to 12.0 mm. Corresponding to the diameter of the shaft 2 of the implant, the diameter of the bar 3 also varies.

The basis for the form of the caps forming a cap set is always the natural tooth form. This makes it possible, for example, to provide at least some of the caps or also all caps in several sizes, for example as different sets of pre-formed caps with different sizes.

Compared with the contour of the natural tooth form, the caps my be reduced in size by a certain dimension, which is for example between 0.1 and 2.5 mm, whereby this dimension does not exceed the usual material thickness of the shell of a single crown, bridge element, telescope, etc. Details are shown in the following table:

### EXAMPLE 1

| | | Mesio- | |
|---|---|---|---|
| | | distal diameter | Labio-buccal-oral |
| Tooth | Cap length | at stage 12 | diameter at stage 12 |
| Upper jaw | | | |
| Middle incisor | 10.5-5.5 | 7.0-4.0 | 6.0-3.0 |
| Side incisor | 9.5-4.5 | 5-2.0 | 5.0-2.0 |
| Canine | 10.0-5.0 | 5.5-2.5 | 7.0-4 |
| First premolar | 8.5-3.5 | 5.0-2.0 | 8.0-4.0 |
| Second premolar | 8.5-3.5 | 5.0-2.0 | 8.0-4.0 |
| First molar | 7.5-2.5 | 8.0-5.0 | 10.0-6.0 |
| Second molar | 7.0-2.5 | 7.0-4.0 | 10.0-4.0 |
| Third olar | 6.5-2.5 | 6.5-2.5 | 9.5-4.0 |
| Lower jaw | | | |
| Middle incisor | 9.0-4.0 | 3.5-2.0 | 5.3-2.3 |
| Side incisor | 9.5-4.5 | 4.0-2.0 | 5.8-2.8 |
| Canine | 11.0-6.0 | 5.5-2.5 | 7.0-4.0 |
| First premolar | 8.0-3.5 | 5.0-2.0 | 6.5-3.5 |
| Second premolar | 8.5-3.0 | 5.0-2.0 | 7.5-4.0 |
| First molar | 7.0-2.5 | 9.0-6.0 | 9.0-5.0 |
| Second molar | 7.0-2.0 | 8.0-5.0 | 9.0-5.0 |
| Third molar | 7.0-2.5 | 7.5-4.5 | 9.0-5.0 |

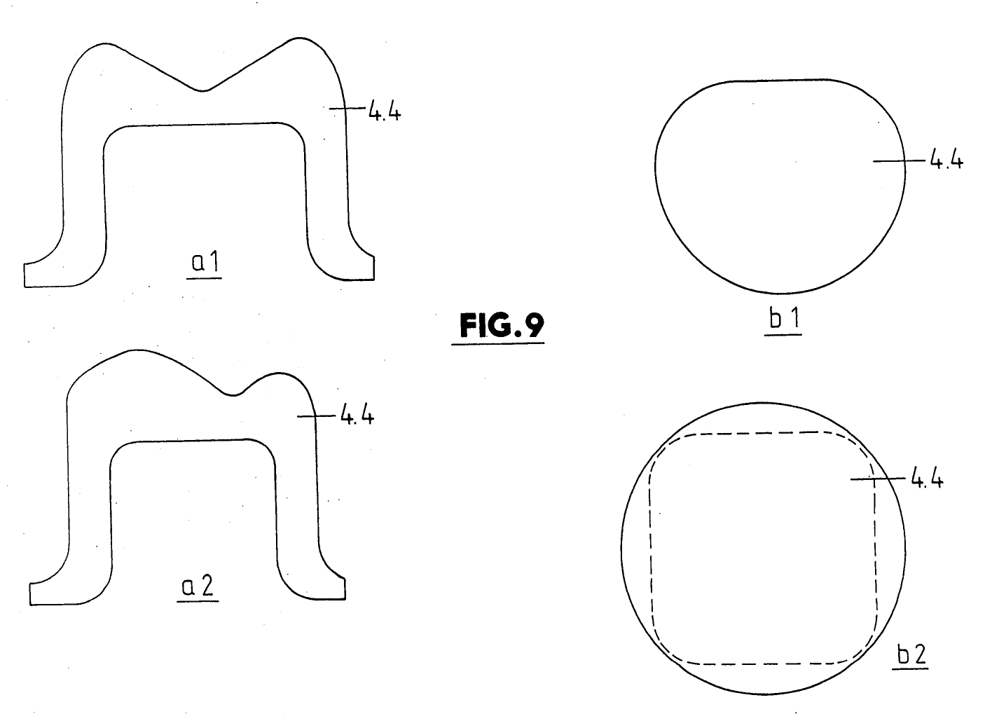

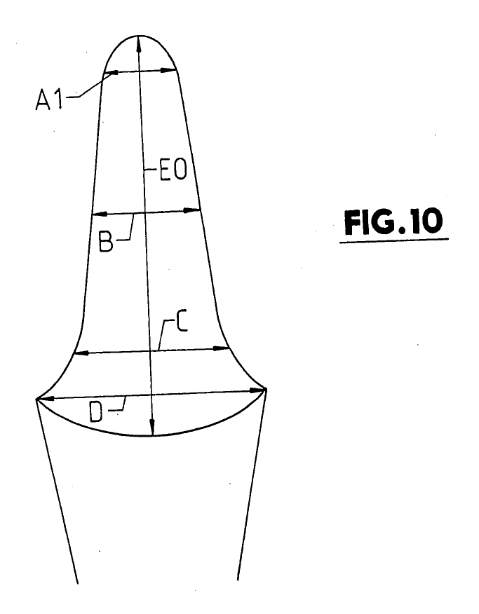

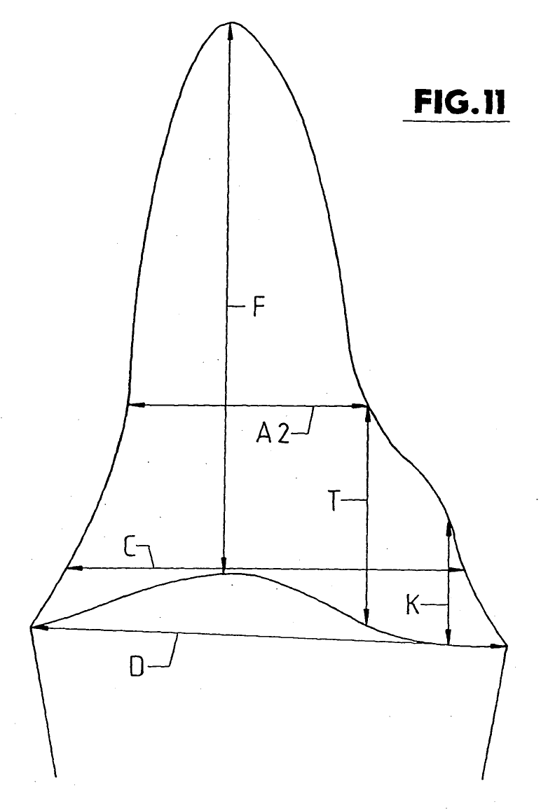

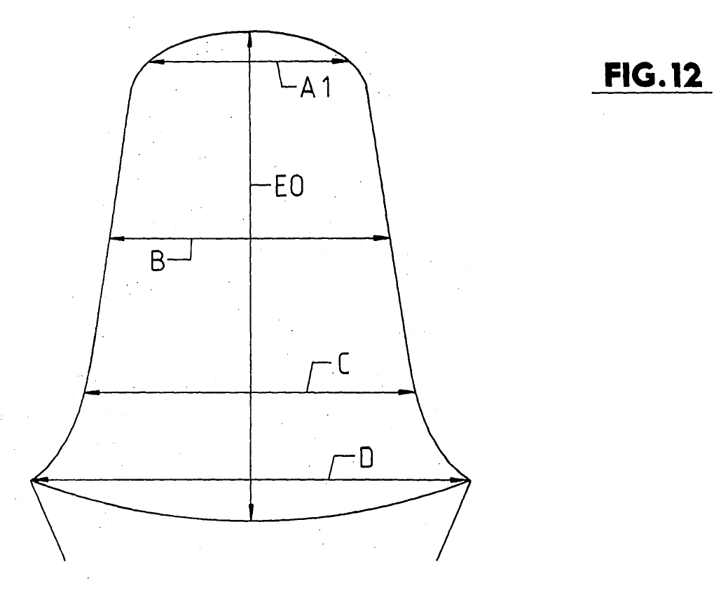

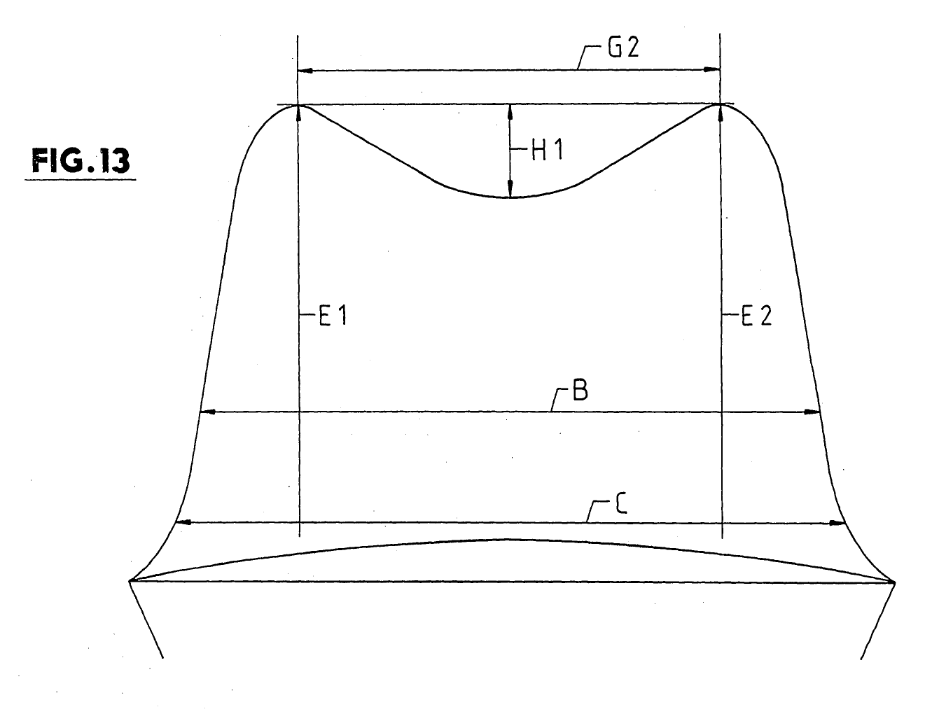

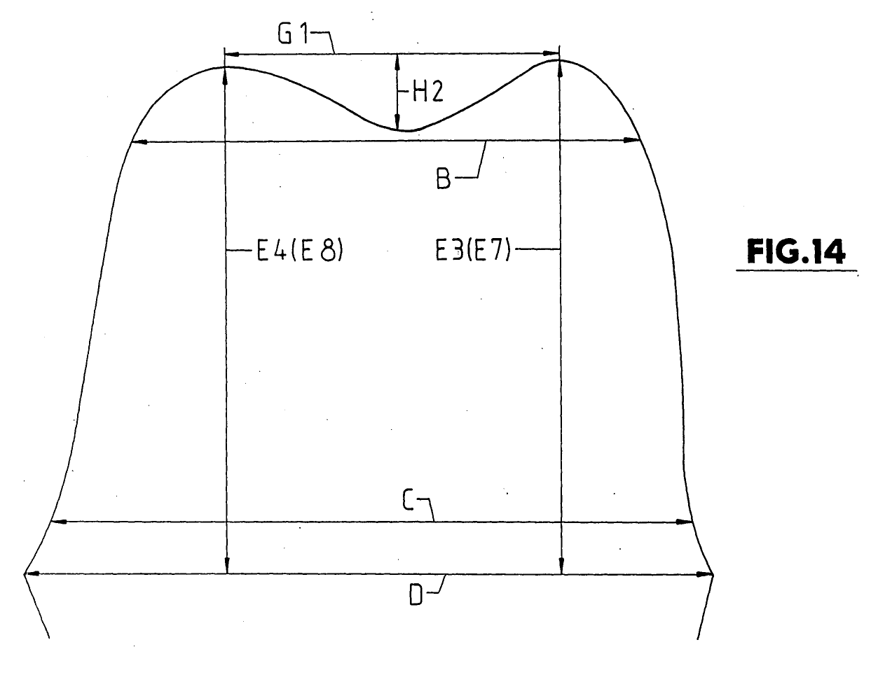

Further examples will be described in connection with FIGS. 10-15 and the respective tables. In these drawings, the respective depicted caps are dimensioned, whereby the following legend applies to the drawings and tables:

A1=diameter of the cap at the top or tip in labial view;

A2=diameter of the cap at the height of the start of the Tuberculum dentis in side view;

B=diameter of the cap in the middle of the cap for front teeth and premolars; for molars, at the transition of the cusps to the body of the cap;

C=diameter of the cap at the stage or in the area of the base;

D=diameter of the cap at the largest circumference in the area of the stage or base;

E0=height of the cap measured between the lowest point of the garland-shaped stage and top side or tip of the cap in labial or buccal, lingual and palatinal view for front teeth and premolars;

F=height of the cap measured between the highest point of the garland-shaped stage to the top of the cap;

G1=cusp distance from buccal-palatinal/lingual view for molars;

G2=cusp distance from mesial-distal view for premolars and molars;

H1=depth of the saddle formed by the cusps on the top of the cap for premolars;

Especially for Premolars:

E1=height of the buccal cusps from side view;

E2=height of the palatinal cusps from side view;

Especially for Caps Based on Molars:

Buccal View:

E3=height of the cap measured between the stage and the mesio-buccal cusp;

E4=height measured between the stage and the disto-buccal cusp

Lingual View:

E7=height of the cap measured between the stage and the mesio-palatinal/lingual cusp

E8=height of the cap measured between the stage and the disto-palatinal/lingual cusp Mesial approximal view:

E5=height measured between the stage and the mesio-buccal cusp

E6=height measured between the stage and the mesio-palatinal/lingual cusp

Disto-Buccal View:

E9=height measured between the stage and the disto-buccal cusp

E10=height measured between the stage and the disto-palatinal/lingual cusp

H2=depth of the saddle in buccal view or palatinal/lingual view

H3=depth of the saddle in side view from mesial and distal direction

Especially for Incisors:

I=height of start of Tuberculum dentis

L=height of end of Tuberculum dentis

The values listed in the following tables can vary by ±0.1 to 3.0 mm.

The height of the stage or the distance of the garland-shaped stage from the garland-shaped bond or connecting surface for the implant shaft can be between 0.2 and 0.6 mm.

Generally, the cap lengths and also the diameters of the caps are such that a cap thickness of at least 0.1 to 0.2 mm, preferably 0.4 to 0.8 mm remains. The cap length is always the length of the cap from the tip to the stage.

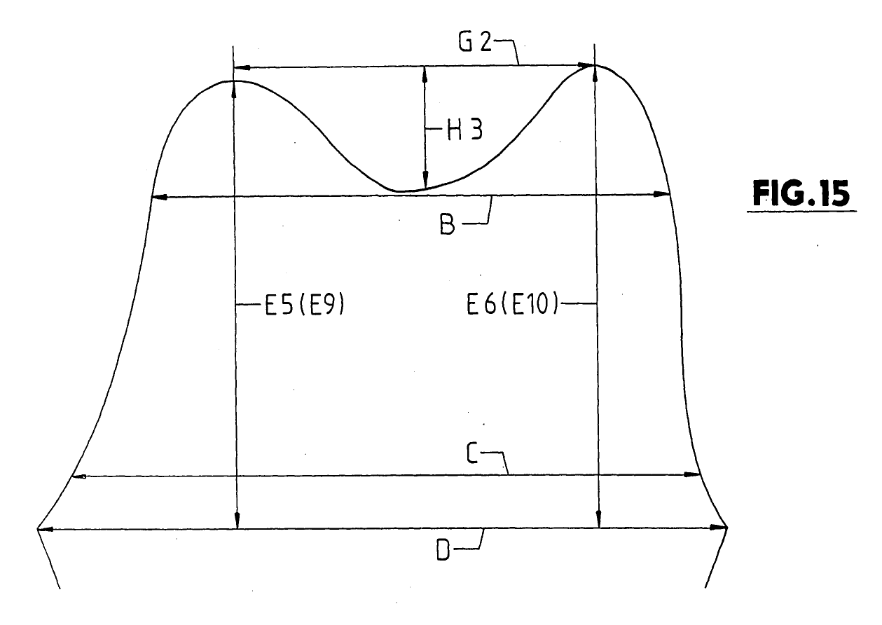

FIG. 16 shows a simplified depiction of a further possible embodiment of an implant 1a with a peg-shaped abutment 4a that has a molded-on peg 16, which fits into a recess 17 of a shaft 2a corresponding to shaft 2.

It was assumed above that the respective cap 4 not only is provided in various forms adapted to the natural tooth form, but also differs in size only slightly from the natural tooth and that for this purpose several sets of caps of different sizes are used.

Generally it is also possible, however, that the caps 4 are still adapted to the natural tooth form, but of a size that is reduced in comparison with the natural tooth form that considerably exceeds the minimum material thickness that is necessary for a shell or other structure. These caps then correspond for example to the caps 4a-4h, but are only similarly reduced in size as compared with the caps 4a-4h. This reduced form eliminates prepping, as a rule. The caps can be used in the same manner as described for the caps 4a-4h, however such that the individual form of the tooth to be reconstructed is achieved by means of the burned-on shell or the structure that may have an increased wall thickness.

It was assumed above that the implant 1 is always used together with a cap 4 or 4a or an abutment, which is pre-fabricated but adapted to the natural tooth form.

However, it is also possible to manufacture the cap 4 in consideration of the further structure (e.g. burned-on ceramic shell, separately manufactured structure, etc.) so that it fits from the beginning, i.e. is adapted to the individual tooth form, with a reduced form using a wax model, with a CAD process using a camera or using a CT process or in another suitable manner.

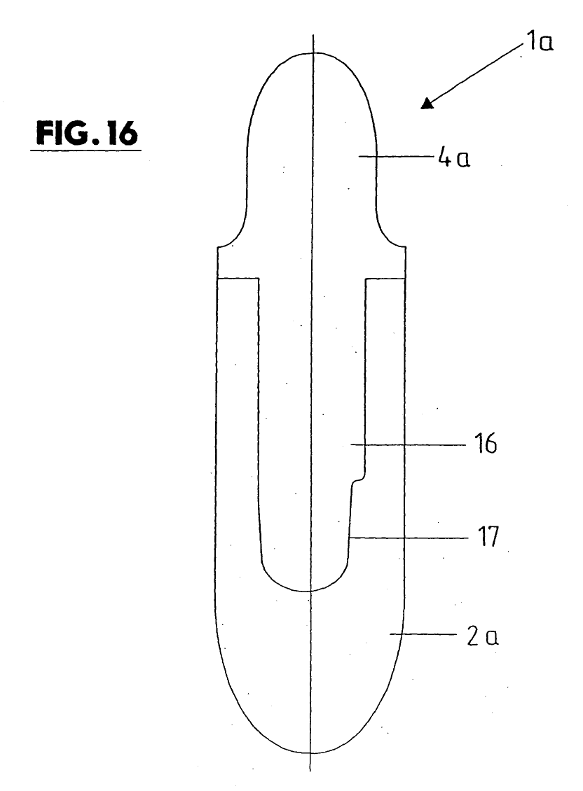

FIG. 17 shows a special situation in which two implants 1 are anchored in the jaw of a patient with strongly diverging longitudinal axes L. A bridge is to be pushed onto both implants 1 and anchored. GA designates a common axis that lies in a common plane with the diverging longitudinal axes L of the two implants 1 and that also corresponds to the direction in which the bridge is to be pushed onto the two implants 1 or onto the compensating caps 8 there; for example, the axis GA is the bisecting line of the two diverging longitudinal axes L.

To make this possible, compensating caps 8 are provided on the implants 1 with a truncated-cone shape in the depicted embodiment, but asymmetric to the respective longitudinal axis L, such that the conicity of the shell surface 9 of the respective compensating cap 8 at the outer area 9.1 of the shell surface 9 facing away from the common axis GA is larger than at the area 9.2 of said shell surface 9 facing said common axis GA. The outer area 9.1 extends at least parallel, preferably slightly conically with an angle of 2-8° to the common axis GA, so that it is possible to push the bridge or the bridge elements onto the compensating caps 8 fastened to the shafts 2. The compensating caps are made of the same material as the caps 4 described above and are connected in the same manner as the caps 4 described above with the shaft 2 or with the bars 3 there. The fact that the shell surface 9 of the compensating caps is asymmetric to the longitudinal axis L as described, results in a sufficient material thickness for the respective compensating cap 8 despite the parallelism of the outer areas 9.1 with the axis GA.

The compensating caps 8 are manufactured individually, for example with the method described above for the individual manufacture of the caps 4. Furthermore, it is possible to use pre-fabricated compensating caps 8 that are likewise adapted to the natural tooth form and that are available in various forms and sizes, e.g. in a compensating cap set. The respective cap 8 is then prepared so that the outer area 9.1 is parallel or slightly conical to the axis GA. The preparation of the compensating caps can take place in a dental lab, for example, in which also the further structure to be anchored to the compensating caps is manufactured, or the compensating caps can be prepared by the dentist on the patient, for example after being fixed onto the healed shaft 2.

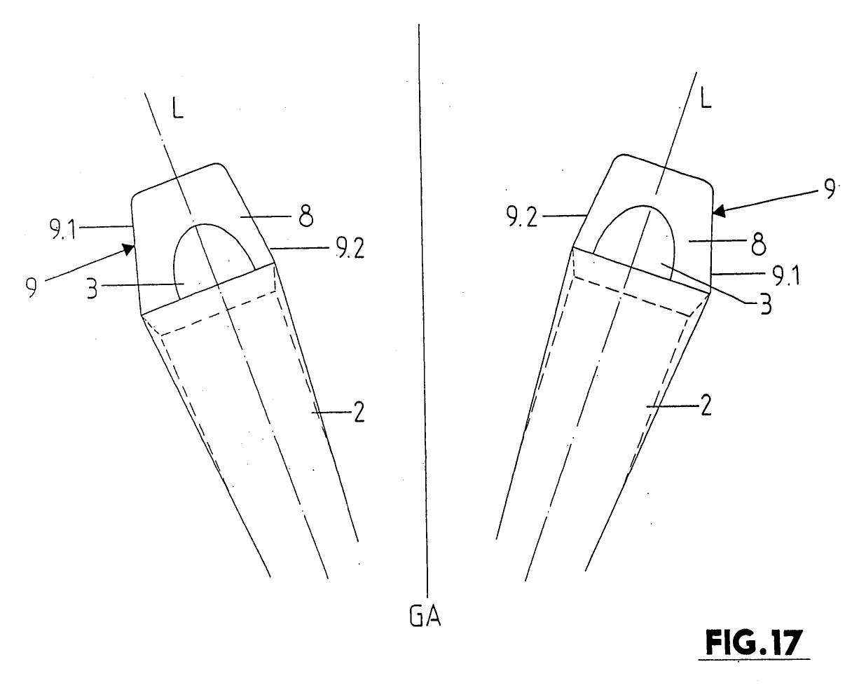

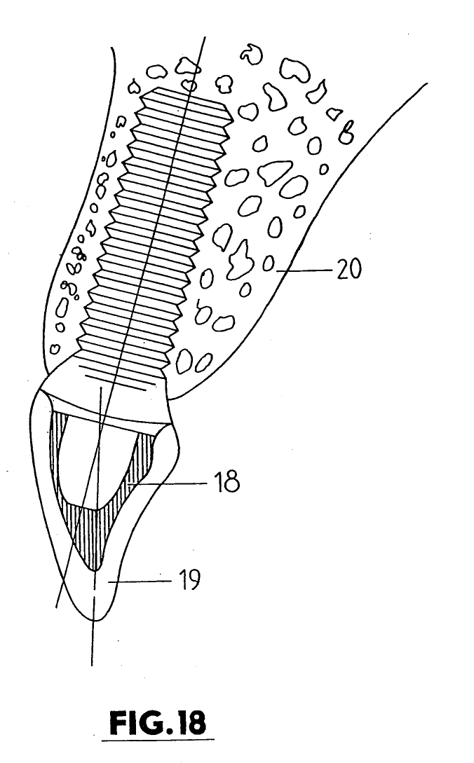

FIG. 18 shows a simplified cross-section of an upper jaw together with the anchored implant there consisting of the shaft 2 and a cap 18, on which a crown 19 is located. The cap 18, which for example is made of the same material as the caps 4 and 8, serves as an axis angle compensation, i.e. the cap 18 is designed so that its cap axis KA forms an angle with the longitudinal axis L of the shaft, for example an angle between approximately 15 and 20°. This makes it possible to anchor the shaft 2 optimally in the upper jaw bone 20 while still achieving the correct position for the crown 19 or the dental prosthesis formed by this crown, which would not be possible with the cap 18.1 depicted in FIG. 19 in position b, in which the recess in the cap is such that the cap axis KA is identical to the longitudinal axis L of the implant. The cap with the axis angle compensation is depicted in a form that is adapted to a front tooth. Of course, other caps with an axis compensation angle are conceivable. Preferably the cap 18 is manufactured individually for the specific application or patient.

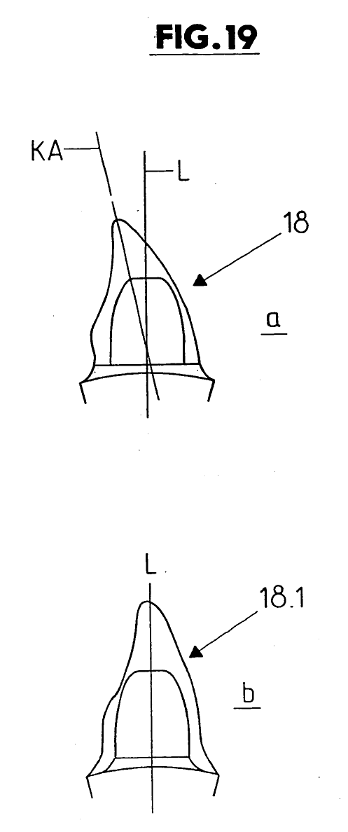

FIG. 20 shows as a further possible embodiment a cap 4.5, which differs from the cap 4.1 essentially in that its form corresponds to the uniform reduction of the form of a natural tooth, which is indicated in FIG. 20 by the dotted line 21.

FIG. 21 shows as a possible embodiment a cap 4.6, the body 4.6.1 of which is formed by the fact that this body is tapered on the outer surface in a straight line upward starting from the stage 12 or base 12.3.

The materials used for the shaft 2, for the caps 4, for the compensating caps 8 and for the caps 18 with the axis angle compensation and for the further structure provided for on the respective cap are generally materials that are optimally selected with respect to their chemical composition, their mechanical stability and strength and their biological compatibility. Suitable materials are for example aluminum oxide, zircon oxide, sintered materials made of metal or ceramic, various metals and metal alloys, such as platinum-iridium, pure gold or galvano gold, or metal alloys that can be burned on. Furthermore, applied layers or shells can be produced for example through spattering, sintering, molding, etc.

The layer thickness of the caps 4 depends on the selection of material. For caps 4 made of aluminum oxide, for example, the layer thickness is between 0.4 and 1.2 mm. For caps 4 made of zircon oxide, for example, the layer thickness is between 0.2 and 0.8 mm.

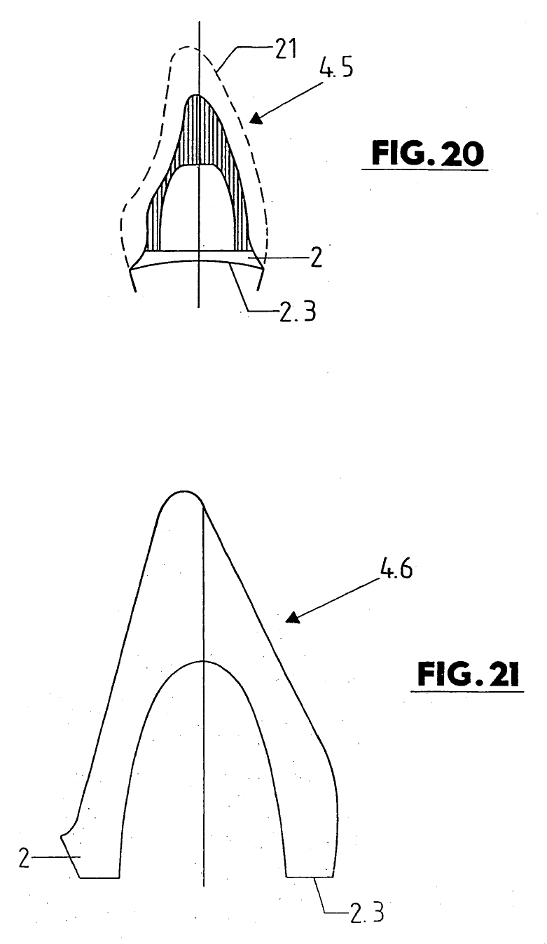

In order to achieve the best possible and strongest bond between the shaft 2 and the respective cap 4 or 8, the cap is surface treated on its surfaces connecting to the shaft, especially in the area of the recess 6 receiving the bar 3, as depicted in FIG. 22 for the cap 4. The surface treated layer indicated by 10 in this Figure is produced for example by etching or by a silicate coating or by means of laser treatment, in such a manner as to achieve an optimum bond of the cap 4 with the adhesive used. The layer 10 can also be a bonding agent layer, i.e. for example an easily etchable layer, for example of silicon oxide.

The layer 10 is covered by an easily removable surface protection layer 11, for example by a layer made of calcium oxide or by a layer made of an adhesive that can be removed using water or acid.

Basically it is also possible to pre-treat the shaft 2 or the bar 3 there accordingly for optimum bonding with the adhesive or to provide it with a bonding agent layer.

Furthermore, it is possible to protect the pretreated surface 10 or a corresponding bonding agent layer by a purely mechanical means of protection, for example in the form of a protective cap or protective sleeve or a removable foil, whereby protective sleeves can be used at the same time to hold back the adhesive or prevent adhesion with surfaces when the adhesive bond between the implant and the cap is produced.

Any protective layers are located primarily on the outer surface of the base element, i.e. in the lower area of the respective cap and/or on the outer surface of the coronal part of the shaft 2 or 2a.

Furthermore, it is also possible, with a cap 4, 8 or 18 that is not pretreated, to pre-treat the surfaces to be bonded with the shaft 2 for an optimum adhesive bond at the time of bonding of the cap, for example by etching. In this case the cap 4 or 8 is made for example of an etchable ceramic at least on its surface provided for the adhesive bond.

The shaft 2 and/or the cap 4 or 8 are, in order to accelerate the healing process, treated with growth factors and/or bactericides or bacteriostatic agents or medications that promote healing, e.g. with P15, BMP 1-7, modified tetracycline, fibrin, CHX concentrate, antibiotics, such as amoxicillin, etc. Independent of this or in addition to this, it is furthermore possible to use a healing cap made of a removable or absorbable material during the healing process, preferably a healing cap made of an elastic material. This healing cap is then preferably formed anatomically correct to the profile of the later crown for optimum stimulation and then likewise contains means such as growth factors, medications, etc. to improve the healing process.

The invention was described above based on exemplary embodiments. It goes without saying that further modifications or variations are possible without abandoning the underlying inventive idea upon which the invention is based.

TABLE 1
Labial view - front teeth - upper jaw

| | | | | | |
|---|---|---|---|---|---|
| Dimensions | A1 | B | C | D | E0 |

Upper middle incisor

| | | | | | |
|---|---|---|---|---|---|
| maximum | 3.2 | 4.2 | 5.6 | 6.7 | 10 |
| minimum | 2.1 | 2.9 | 3.4 | 5.3 | 6.6 |
| mean value | 2.736 | 3.609 | 4.300 | 5.981 | 8.345 |
| standard deviation | 0.377 | 0.375 | 0.583 | 0.773 | 1.084 |

Upper side incisor

| | | | | | |
|---|---|---|---|---|---|
| maximum | 2.4 | 3.6 | 4.3 | 5.4 | 9.5 |
| minimum | 1.1 | 1.9 | 2.2 | 3.2 | 6.7 |
| mean value | 1.933 | 2.741 | 3.083 | 4.591 | 7.65 |
| standard deviation | 0.411 | 0.479 | 0.542 | 0.831 | 1.052 |

Upper canine

| | | | | | |
|---|---|---|---|---|---|
| maximum | 2.9 | 3.8 | 4.3 | 6.1 | 11.2 |
| minimum | 1.7 | 3.1 | 3.5 | 4.5 | 7.1 |
| mean value | 2.290 | 3.450 | 3.950 | 5.610 | 9.240 |
| standard deviation | 0.363 | 0.227 | 0.295 | 0.474 | 1.443 |

TABLE 2
Buccal and palatinal view - premolars - upper jaw

| | | | | | | | | | | |
|---|---|---|---|---|---|---|---|---|---|---|
| | A1 | | B | | C | | D | | E0 | |
| Diemnsions | bucc | pal | bucc | pal | bucc | pal | bucc | pal | bucc | pal |

Upper no. 1 premolar

| | | | | | | | | | | |
|---|---|---|---|---|---|---|---|---|---|---|
| maximum | 2.6 | 2.7 | 4 | 3.7 | 4.3 | 4 | 5.3 | 5.3 | 7.6 | 5.9 |
| minimum | 1.3 | 1.4 | 2.3 | 2.1 | 2.7 | 3.4 | 3.8 | 3.7 | 4.6 | 3.5 |
| mean value | 2.058 | 1.975 | 3.083 | 2.916 | 3.567 | 3.408 | 4.666 | 4.55 | 6.441 | 4.658 |
| standard deviation | 0.37 | 0.398 | 0.539 | 0.45 | 0.571 | 0.456 | 0.51 | 0.509 | 0.827 | 0.662 |

Upper no. 2 premolar

| | | | | | | | | | | |
|---|---|---|---|---|---|---|---|---|---|---|
| maximum | 2.3 | 2.7 | 3.8 | 3.5 | 4.2 | 4.1 | 5.4 | 4.9 | 7.3 | 6.7 |
| minimum | 1.3 | 1.2 | 2.2 | 2.1 | 2.5 | 2.4 | 3.3 | 3.4 | 3.7 | 2.8 |
| mean value | 1.841 | 1.975 | 2.966 | 2.916 | 3.375 | 3.4 | 4.341 | 4.441 | 5.808 | 5.075 |
| standard deviation | 0.277 | 0.42 | 0.549 | 0.472 | 0.578 | 0.488 | 0.624 | 0.442 | 1.078 | 0.999 |

TABLE 3
Buccal and palatinal view - molars - upper jaw

| | G1 | | B | | C | | D | | E | | H2 | | E | |
|---|---|---|---|---|---|---|---|---|---|---|---|---|---|---|
| Dimensions | bucc | pal | bucc | pal | bucc | pal | bucc | pal | 4 bucc | 8 pal | bucc | pal | 3 bucc | 7 pal |

Upper no. 1 molar

| | | | | | | | | | | | | | | |
|---|---|---|---|---|---|---|---|---|---|---|---|---|---|---|
| maximum | 3.40 | 4.10 | 6.00 | 7.40 | 7.30 | 7.30 | 8.50 | 8.80 | 6.90 | 10.30 | 0.50 | 0.60 | 7.80 | 9.20 |
| minimum | 2.40 | 2.10 | 4.70 | 4.20 | 5.50 | 4.90 | 5.80 | 5.30 | 3.9 | 2.80 | 0.00 | 0.00 | 3.80 | 3.20 |
| mean value | 3.058 | 3.108 | 5.383 | 5.550 | 6.283 | 6.033 | 7.200 | 6.941 | 5.233 | 4.966 | 0.216 | 0.208 | 5.475 | 5.225 |
| standard | 0.362 | 0.555 | 0.478 | 0.881 | 0.498 | 0.819 | 0.768 | 0.983 | 0.917 | 2.065 | 0.180 | 0.219 | 1.374 | 1.597 |
| deviation | | | | | | | | | | | | | | |

Upper no. 2 molar

| | | | | | | | | | | | | | | |
|---|---|---|---|---|---|---|---|---|---|---|---|---|---|---|
| maximum | 4.3 | 3.9 | 6.8 | 6.3 | 7.8 | 6.8 | 8.2 | 7.7 | 6.3 | 5.6 | 0.3 | 0.2 | 6.9 | 5.4 |
| minimum | 2.10 | 1.70 | 4.10 | 3.50 | 4.50 | 3.60 | 5.60 | 5.30 | 3.50 | 2.30 | 0.00 | 0.00 | 2.90 | 2.70 |
| mean value | 3.28 | 2.95 | 5.18 | 4.83 | 5.85 | 5.26 | 6.95 | 6.32 | 5.00 | 3.95 | 0.11 | 0.03 | 4.98 | 3.94 |
| standard | 0.634 | 0.688 | 0.840 | 0.762 | 0.985 | 0.938 | 0.722 | 0.784 | 0.878 | 1.221 | 0.125 | 0.075 | 1.243 | 0.950 |
| deviation | | | | | | | | | | | | | | |

TABLE 4
Labial view - incisors - lower jaw

| | | | | | |
|---|---|---|---|---|---|
| Dimensions | A1 | B | C | D | E0 |

Lower middle incisor

| | | | | | |
|---|---|---|---|---|---|
| maximum | 2.50 | 3.70 | 4.30 | 6.00 | 9.10 |
| minimum | 1.20 | 1.80 | 2.10 | 2.80 | 6.90 |
| mean value | 1.650 | 2.308 | 2.733 | 3.691 | 7.775 |
| standard deviation | 0.384 | 0.591 | 0.752 | 1.188 | 0.775 |

Lower side incisor

| | | | | | |
|---|---|---|---|---|---|
| maximum | 2.40 | 2.90 | 3.60 | 4.20 | 8.40 |
| minimum | 1.20 | 1.90 | 2.30 | 2.90 | 6.40 |
| mean value | 1.616 | 2.283 | 2.741 | 3.491 | 7.308 |
| standard deviation | 0.358 | 0.255 | 0.396 | 0.418 | 0.546 |

Lower canine

| | | | | | |
|---|---|---|---|---|---|
| maximum | 3.40 | 4.20 | 5.00 | 6.20 | 10.30 |
| minimum | 1.60 | 2.40 | 3.20 | 4.00 | 6.70 |
| mean value | 2.470 | 3.340 | 3.970 | 5.04 | 8.570 |
| standard deviation | 0.590 | 0.503 | 0.648 | 0.751 | 1.194 |

TABLE 5
Buccal and lingual view - premolars - lower jaw

| | A1 | | B | | C | | D | | E0 | |
|---|---|---|---|---|---|---|---|---|---|---|
| Dimensions | bucc | ling | bucc | ling | bucc | ling | bucc | ling | bucc | ling |

Lower no. 1 premolar

| | | | | | | | | | | |
|---|---|---|---|---|---|---|---|---|---|---|
| maximum | 2.90 | 2.4 | 3.90 | 3.9 | 4.60 | 4.2 | 5.60 | 5.5 | 8.90 | 7.4 |
| minimum | 1.70 | 1.8 | 2.70 | 2.3 | 3.20 | 2.6 | 3.90 | 3.7 | 5.90 | 3.8 |
| mean value | 2.263 | 2.081 | 3.154 | 3.009 | 3.645 | 3.354 | 4.681 | 4.209 | 7.454 | 5.6 |
| standard deviation | 0.352 | 0.194 | 0.398 | 0.508 | 0.418 | 0.524 | 0.475 | 0.548 | 0.868 | 1.435 |

Lower no. 2 premolar

| | | | | | | | | | | |
|---|---|---|---|---|---|---|---|---|---|---|
| maximum | 3.10 | 2.9 | 4.00 | 4 | 4.50 | 4.6 | 5.70 | 5.9 | 8.10 | 5.9 |
| minimum | 2.00 | 1.7 | 3.00 | 2.7 | 3.70 | 3.1 | 4.20 | 4.2 | 4.10 | 3.5 |
| mean value | 2.381 | 2.163 | 3.463 | 3.227 | 4.100 | 3.736 | 5.063 | 4.745 | 7.063 | 4.563 |
| standard deviation | 0.373 | 0.304 | 0.280 | 0.395 | 0.296 | 0.443 | 0.39 | 0.425 | 1.130 | 0.651 |

TABLE 6
Buccal and lingual view - molars - lower jaw

| | G1 | | B | | C | | D | | E | | H2 | | E | |
|---|---|---|---|---|---|---|---|---|---|---|---|---|---|---|
| Dimensions | bucc | ling | bucc | ling | bucc | ling | bucc | ling | 4 bucc | 8 ling | bucc | ling | 3 bucc | 7 ling |

Lower no. 1 molar

| | | | | | | | | | | | | | | |
|---|---|---|---|---|---|---|---|---|---|---|---|---|---|---|
| maximum | 5.10 | 5.60 | 8.00 | 8.00 | 8.00 | 8.70 | 10.10 | 9.90 | 6.40 | 7.30 | 0.60 | 0.90 | 8.10 | 6.80 |
| minimum | 2.80 | 3.00 | 5.50 | 3.90 | 5.10 | 4.10 | 6.50 | 4.40 | 3.80 | 2.90 | 0.00 | 0.00 | 3.10 | 3.00 |
| mean value | 3.954 | 4.172 | 6.327 | 6.200 | 6.918 | 6.890 | 8.590 | 8.454 | 5.090 | 4.381 | 0.254 | 0.254 | 5.518 | 4.118 |
| standard | 0.720 | 0.922 | 0.743 | 1.063 | 0.815 | 1.149 | 1.070 | 1.497 | 1.074 | 1.192 | 0.216 | 0.317 | 1.753 | 1.148 |
| deviation | | | | | | | | | | | | | | |

Lower no. 2 molar

| | | | | | | | | | | | | | | |
|---|---|---|---|---|---|---|---|---|---|---|---|---|---|---|
| maximum | 5.40 | 6.00 | 7.80 | 8.20 | 8.80 | 9.10 | 9.60 | 9.90 | 6.50 | 5.80 | 0.70 | 0.70 | 7.60 | 6.90 |
| minimum | 3.40 | 4.00 | 6.20 | 6.70 | 7.10 | 7.00 | 8.50 | 8.50 | 3.20 | 3.10 | 0.00 | 0.00 | 2.90 | 2.90 |
| mean value | 4.366 | 4.933 | 7.166 | 5.488 | 7.877 | 5.967 | 9.144 | 9.155 | 4.800 | 4.466 | 0.266 | 0.233 | 5.466 | 4.840 |
| standard | 0.681 | 0.751 | 0.476 | 0.487 | 0.632 | 0.690 | 0.444 | 0.490 | 1.136 | 0.911 | 0.244 | 0.259 | 1.746 | 1.285 |
| deviation | | | | | | | | | | | | | | |

Lower no. 3 molar

| | | | | | | | | | | | | | | |
|---|---|---|---|---|---|---|---|---|---|---|---|---|---|---|
| maximum | 5.90 | 5.20 | 7.70 | 7.20 | 7.90 | 7.80 | 9.00 | 7.90 | 4.70 | 3.10 | 0.10 | 0.00 | 5.40 | 4.40 |
| minimum | 3.59 | 3.50 | 5.40 | 6.60 | 7.00 | 6.40 | 7.30 | 7.70 | 2.30 | 3.00 | 0.00 | 0.00 | 4.70 | 3.40 |
| mean value | 4.700 | 4.350 | 6.550 | 6.900 | 7.450 | 7.100 | 8.150 | 7.80 | 3.500 | 3.050 | 0.050 | 0.000 | 5.050 | 3.900 |
| standard | 1.697 | 1.202 | 1.626 | 0.424 | 0.636 | 0.989 | 1.202 | 0.141 | 1.697 | 0.070 | 0.070 | 0.000 | 0.494 | 0.707 |
| deviation | | | | | | | | | | | | | | |

TABLE 7
Side view - front teeth - upper jaw

| | | | | | | |
|---|---|---|---|---|---|---|
| Dimensions | A2 | C | D | F | I | K |

Upper middle incisor

| | | | | | | |
|---|---|---|---|---|---|---|
| maximum | 3.9 | 5.2 | 7.1 | 9.9 | 3.8 | 1.9 |
| minimum | 2.2 | 4.1 | 5.3 | 6 | 2 | 1.1 |
| mean value | 2.690 | 4.509 | 5.945 | 6.981 | 2.854 | 1.563 |
| standard | 0.463 | 0.361 | 0.494 | 1.235 | 0.689 | 0.287 |
| deviation | | | | | | |

Upper side incisor

| | | | | | | |
|---|---|---|---|---|---|---|
| maximum | 2.6 | 4.3 | 7 | 8.6 | 3.6 | 2.2 |
| minimum | 1.8 | 3.2 | 4.8 | 4.9 | 2.1 | 1 |
| mean value | 2.281 | 3.8 | 5.709 | 6.409 | 2.872 | 1.645 |
| standard | 0.222 | 0.293 | 0.759 | 1.124 | 0.542 | 0.329 |
| deviation | | | | | | |

Upper canine

| | | | | | | |
|---|---|---|---|---|---|---|
| maximum | 3.8 | 6 | 8.1 | 9.3 | 4.8 | 2.8 |
| minimum | 2.2 | 4.2 | 5.5 | 5.7 | 2.4 | 1 |
| mean value | 2.940 | 5.140 | 7.000 | 7.510 | 3.340 | 1.710 |
| standard | 0.469 | 0.600 | 0.809 | 1.233 | 0.832 | 0.544 |
| deviation | | | | | | |

TABLE 8
Side view - premolars - upper jaw

| | | | | | | | |
|---|---|---|---|---|---|---|---|
| Dimensions | G2 | B | C | D | E1 | H1 | E2 |

Upper no. 1 premolar

| | | | | | | | |
|---|---|---|---|---|---|---|---|
| maximum | 5.3 | 7.1 | 7.8 | 8.8 | 7.7 | 1.2 | 5.6 |
| minimum | 2.9 | 5.2 | 5.9 | 7.2 | 4.4 | 0.4 | 3.7 |
| mean value | 4.175 | 6.116 | 6.566 | 7.908 | 5.325 | 0.791 | 4.466 |
| standard deviation | 0.748 | 0.523 | 0.613 | 0.541 | 0.951 | 0.239 | 0.996 |

Upper no. 2 premolar

| | | | | | | | |
|---|---|---|---|---|---|---|---|
| maximum | 5 | 6.7 | 7.5 | 8.7 | 6.9 | 1 | 6.8 |
| minimum | 2.2 | 4.6 | 4.4 | 5.6 | 4 | 0.3 | 3.6 |
| mean value | 3.93 | 5.646 | 6.215 | 7.592 | 5.184 | 0.661 | 4.846 |
| standard deviation | 0.795 | 0.798 | 0.854 | 0.892 | 0.889 | 0.198 | 0.885 |

TABLE 9
Side view - molars - upper jaw/mesial and distal

| | G2 | | B | | C | | D | | E | | H3 | | E | |
|---|---|---|---|---|---|---|---|---|---|---|---|---|---|---|
| Dimensions | mes | dist | mes | dist | mes | dist | mes | dist | 5 mes | 9 dist | mes | dist | 6 mes | 10 dist |

Upper no. 1 molar

| | | | | | | | | | | | | | | |
|---|---|---|---|---|---|---|---|---|---|---|---|---|---|---|
| maximum | 6.40 | 6.50 | 8.70 | 8.80 | 9.70 | 9.00 | 11.90 | 10.70 | 6.30 | 7.80 | 1.20 | 1.00 | 6.20 | 8.80 |
| minimum | 4.50 | 3.80 | 6.70 | 6.40 | 7.70 | 7.10 | 8.80 | 8.40 | 3.90 | 4.50 | 0.40 | 0.40 | 3.20 | 3.00 |
| mean value | 5.440 | 5.060 | 7.970 | 7.710 | 8.790 | 8.290 | 10.520 | 9.620 | 5.040 | 5.560 | 0.760 | 0.810 | 4.900 | 5.290 |
| standard | 0.611 | 0.798 | 0.539 | 0.756 | 0.627 | 0.631 | 1.015 | 0.801 | 1.016 | 1.075 | 0.250 | 0.166 | 0.959 | 1.642 |
| deviation | | | | | | | | | | | | | | |

Upper no. 2 molar

| | | | | | | | | | | | | | | |
|---|---|---|---|---|---|---|---|---|---|---|---|---|---|---|
| maximum | 7.50 | 6.30 | 9.40 | 8.50 | 9.90 | 9.10 | 11.50 | 10.40 | 7.30 | 6.60 | 1.90 | 1.60 | 6.40 | 5.40 |
| minimum | 3.10 | 2.80 | 5.20 | 5.10 | 6.70 | 6.20 | 8.80 | 7.90 | 4.30 | 3.50 | 0.20 | 0.50 | 3.30 | 3.50 |
| mean value | 5.309 | 4.772 | 7.263 | 6.745 | 8.454 | 7.536 | 10.040 | 9.027 | 5.263 | 5.145 | 0.727 | 0.890 | 4.390 | 4.281 |
| preferred value | 1.576 | 1.088 | 1.377 | 1.009 | 1.072 | 0.959 | 1.026 | 0.797 | 0.818 | 0.802 | 0.494 | 0.336 | 0.780 | 0.663 |

TABLE 10
Side view - front teeth - lower jaw

| | | | | | | |
|---|---|---|---|---|---|---|
| Dimensions | A2 | B | D | F | I | K |

Lower middle incisor

| | | | | | | |
|---|---|---|---|---|---|---|
| maximum | 3.10 | 4.60 | 6.50 | 7.10 | 3.60 | 2.40 |
| minimum | 1.70 | 3.30 | 4.70 | 4.70 | 1.90 | 1.10 |
| mean value | 2.291 | 4.091 | 5.433 | 6.167 | 2.608 | 1.633 |
| standard | 0.391 | 0.387 | 0.609 | 0.743 | 0.553 | 0.396 |
| deviation | | | | | | |

Lower side incisor

| | | | | | | |
|---|---|---|---|---|---|---|
| maximum | 3.30 | 5.50 | 7.20 | 7.00 | 3.30 | 2.70 |
| minimum | 2.10 | 3.80 | 4.70 | 4.50 | 1.70 | 1.10 |
| mean value | 4.758 | 4.650 | 5.933 | 6.108 | 2.641 | 1.691 |
| standard | 0.444 | 0.593 | 0.884 | 0.911 | 0.518 | 0.460 |
| deviation | | | | | | |

Lower canine

| | | | | | | |
|---|---|---|---|---|---|---|
| maximum | 5.10 | 6.80 | 7.80 | 10.20 | 3.90 | 2.90 |
| minimum | 2.40 | 4.50 | 6.30 | 4.60 | 2.00 | 1.10 |
| mean value | 3.827 | 5.618 | 7.109 | 7.181 | 3.081 | 1.972 |
| standard | 0.819 | 0.695 | 0.461 | 1.663 | 0.729 | 0.526 |
| deviation | | | | | | |

TABLE 11
Side view - premolars - lower jaw

| | | | | | | |
|---|---|---|---|---|---|---|
| G2 | B | C | D | E1 | H1 | E2 |

Lower no. 1 premolar

| | | | | | | | | |
|---|---|---|---|---|---|---|---|---|
| Dimen- | maximum | 4.50 | 6.20 | 6.40 | 7.70 | 8.80 | 0.60 | 7.60 |
| sions | minimum | 1.90 | 4.10 | 4.10 | 5.20 | 4.40 | 0.10 | 3.50 |
| | mean value | 2.936 | 4.836 | 5.200 | 6.19 | 5.890 | 0.454 | 5.063 |
| | standard | 0.727 | 0.739 | 0.667 | 0.996 | 1.398 | 0.136 | 1.347 |
| | deviation | | | | | | | |

Lower no. 2 premolar

| | | | | | | | |
|---|---|---|---|---|---|---|---|
| maximum | 4.00 | 5.40 | 6.30 | 8.00 | 7.90 | 0.80 | 4.90 |
| minimum | 3.00 | 4.70 | 5.20 | 5.50 | 3.70 | 0.10 | 3.20 |
| mean value | 3.510 | 5.150 | 5.620 | 6.66 | 5.560 | 0.520 | 4.090 |
| standard | 0.360 | 0.259 | 0.326 | 0.816 | 1.581 | 0.229 | 0.611 |
| deviation | | | | | | | |

TABLE 12
Side view - molars - lower jaw/mesial and distal

| | | | | | | | | E | | | | E | |
|---|---|---|---|---|---|---|---|---|---|---|---|---|---|
| G2 | | B | | C | | D | | 5 | 9 | H3 | | 6 | 10 |
| mes | dist | mes | dist | mes | dist | mes | dist | mes | dist | mes | dist | mes | dist |

Lower no. 1 molar

| | | | | | | | | | | | | | | | |
|---|---|---|---|---|---|---|---|---|---|---|---|---|---|---|---|
| Dimensions | maximum | 5.00 | 4.90 | 6.70 | 6.90 | 7.80 | 7.60 | 9.50 | 8.90 | 7.40 | 7.10 | 0.70 | 0.60 | 5.00 | 5.40 |
| | minimum | 2.40 | 2.20 | 4.80 | 4.90 | 6.20 | 5.80 | 7.20 | 6.40 | 2.50 | 3.00 | 0.20 | 0.30 | 2.90 | 1.70 |
| | mean value | 4.022 | 3.833 | 5.911 | 5.844 | 6.888 | 6.633 | 8.600 | 7.933 | 4.422 | 4.277 | 0.489 | 0.477 | 3.600 | 3.766 |
| | standard deviation | 0.754 | 0.838 | 0.615 | 0.716 | 0.586 | 0.680 | 0.923 | 0.831 | 1.363 | 1.212 | 0.138 | 0.093 | 0.700 | 1.083 |

Lower no. 2 molar

| | | | | | | | | | | | | | | |
|---|---|---|---|---|---|---|---|---|---|---|---|---|---|---|
| maximum | 6.10 | 5.40 | 8.10 | 7.40 | 8.50 | 8.00 | 9.80 | 9.00 | 7.70 | 7.10 | 0.80 | 0.90 | 7.00 | 6.30 |
| minimum | 4.30 | 3.00 | 4.90 | 5.30 | 6.50 | 5.80 | 7.20 | 6.50 | 3.70 | 2.80 | 0.10 | 0.10 | 3.30 | 3.00 |
| mean value | 4.672 | 4.554 | 6.700 | 6.336 | 7.518 | 7.000 | 8.781 | 7.981 | 5.509 | 4.500 | 0.518 | 0.545 | 4.963 | 4.518 |
| standard deviation | 0.754 | 0.729 | 0.920 | 0.755 | 0.814 | 0.700 | 0.847 | 0.894 | 1.341 | 1.518 | 0.222 | 0.246 | 1.170 | 1.129 |

Lower no. 3 molar

| | | | | | | | | | | | | | | |
|---|---|---|---|---|---|---|---|---|---|---|---|---|---|---|
| maximum | 5.50 | 4.10 | 7.60 | 5.40 | 8.80 | 7.70 | 9.90 | 8.70 | 4.90 | 2.80 | 0.80 | 0.90 | 4.80 | 3.60 |
| minimum | 3.60 | 3.30 | 5.00 | 4.50 | 5.60 | 5.00 | 6.30 | 5.20 | 3.90 | 1.60 | 0.50 | 0.30 | 4.00 | 3.00 |
| mean value | 4.550 | 3.700 | 6.300 | 4.950 | 7.200 | 6.350 | 8.100 | 6.95 | 4.400 | 2.800 | 0.650 | 0.600 | 4.400 | 3.300 |
| standard deviation | 1.343 | 0.565 | 1.838 | 0.636 | 2.262 | 1.909 | 2.545 | 2.474 | 0.707 | 1.697 | 0.212 | 0.424 | 0.565 | 0.424 |

### REFERENCE NUMBERS

1, 1a implant
2, 2a root shaft of implant
3 retention bar
4, 4a cap
4.1-4.3 cap form
5 burned-on layer or shell
6 recess of cap
7 separate structure placed on the cap 4
8 compensating cap
9 shell surface of compensating cap
9.1 outer area
9.2 inner area
10 layer produced by surface treatment
11 protective layer
12 stage
13 transition
14 taper
15 tip of cap
16 molded-on bar
17 recess
18 cap or abutment with axial angle compensation
19 crown
20 upper jaw bone
SH stage height
ST stage depth
L longitudinal axis of implant
GA common axis of two diverging longitudinal implant axes
K abutment body
V

1. An abutment for a tooth implant with a root section or shaft that can be anchored in a jaw, and onto the coronal area of which the abutment can be fixed, wherein
the abutment is part of at least one set of pre-fabricated abutments, which differ in form and each of which is adapted to a natural form of a tooth.

2. The abutment as claimed in claim 1, further comprising several sets with differing abutments each adapted to the natural form of a tooth, whereby the abutments vary in size from set to set.

3. The abutment as claimed in claim 1, wherein characterized in that the abutment corresponds to the reduced natural form of front tooth, a premolar or a molar.

4. The abutment as claimed in claim 1, wherein the abutment set has a reduced number of abutments with different forms, only abutments that correspond to the reduced natural form of a front tooth, a premolar or a molar.

5. The abutment as claimed the abutments in comparison with the natural tooth form are smaller by a dimension that is less than or equal to the wall thickness of a further structure to be provided on the abutment.

6. The abutment as claim 1, wherein an outer contour of the respective abutment as compared with an outer contour of the form a natural tooth is reduced by approximately 0.1 to 2.5 mm.

7. The abutment as claimed claim 1, wherein the abutment is made of aluminum oxide, zircon oxide, metal or a high-strength material.

8. The abutment as claimed claim 7, wherein the abutment made of aluminum oxide has a wall thickness of at least 0.2 to 1.2 mm.

9. The abutment as claimed in claim 7, wherein abutment made of zircon oxide has a wall thickness of at least 0.15 to 0.8 mm.

10. The abutment as claimed in claim 1, wherein a the coronal area of the implant shaft consists of a bar or a bar-like projection and that the abutment has a recess adapted to the form of the bar.

11. The abutment as claimed in claim 1, wherein the abutment is pre-treated on a surface to be connected with an implant shaft for optimization of the adhesive bond, by means of mechanical roughening, etching and/or coating with an active layer reacting with a bonding agent of the adhesive bond.

12. The abutment as claimed in claim 11, further comprising a protective layer for covering the surface-treated layer.

13. The abutment as claimed in claim 1, wherein the abutment is designed to be able to be etched on its surface the an adhesive bond with the implant shaft an etchable surface layer is composed of silicon oxide.

14. The abutment as claimed in claim 1, wherein the abutment is a basis for an additional structure.

15. The abutment as claimed in claim 14, wherein the abutment is the basis for a crown with a shell forming anouter surface of the crown burned, cast or sintered onto the abutment.

16. The abutment as claimed in claim 14, wherein the abutment is the basis for a separately manufactured structure, the structure is a shell, crown, a bridge element, a telescope or bar.

17. The abutment as claimed in claim 1, wherein the abutment a compensating cap with a truncated cone-shaped coronal area, a shell surface of which is asymmetric to a longitudinal implant axis such that the shell surface has a different conical shape at two areas opposing the longitudinal implant axis.

18. The abutment as claimed in claim 1, wherein the abutment is a cap.

19. The abutment as claimed claim 1, wherein an axis of the abutment forms an angle with the longitudinal axis of the implant or of the root shaft, the angle up to approximately 20°.

20. The abutment as claimed in claim 1, wherein a basis or stage of the abutment has a garland-shaped course and that a lowest point of this course is buccal-labial and lingual-palatinal.

21. The abutment as claimed in claim 20, wherein the buccal-labial distance between the lowest point of the garland-shaped course to the tip of the abutment is different from the corresponding palatinal-lingual distance.

22. The abutment as claimed in claim 1, wherein on an outer surface of a base part of the abutment and/or on the outer surface of the coronal part of the shaft there is a protective layer or protective sleeve covering these surfaces.

23. The abutment as claimed in claim 1, wherein the abutment and/or shaft is provided with growth factors and/or substances to accelerate healing, the growth factors are bacteriocidal or bacteriostatic agents, or medications.

24. The abutment as claimed in cclaim 1, wherein the individual anatomical structural form corresponds to an even reduction around the natural tooth.

25. The abutment as claimed claim 1, wherein an outer form of the abutment is stylized and has straight surfaces and rounded edges and is schematically equivalent, with a reduction to a greater or lesser extent, to the tooth to be replaced.

26. The abutment as claimed claim 1, wherein there is an absolute or relative height difference between the premolar and molar cusps and a garland-shaped base and stage in an upper jaw/lower jaw.

27. The abutment as claimed in claim 1, wherein a form of the abutment in top view, in an area of the passage through the soft tissue and in the area of the base is similar to the corresponding natural teeth, as follows:
Upper jaw no. 1: nearly same diameter m/d and b/p, round or square toward distal somewhat convex;
Upper jaw no. 2: as upper jaw no. 1, but somewhat more oval, in labio-palatinal direction;
Upper jaw no. 3: spheroidal oval with distal convexity;
Upper jaw no. 4: double oval/figure eight form;
Upper jaw no. 5: oblong oval;
Lower jaw no. 1 and 2: ditto, triangular with reduction toward palatinal;
Lower jaw no. 3: similar, somewhat more round;
Lower jaw no. 4 and 5: oblong oval, somewhat triangular course toward buccal;
Lower jaw no. 6/7/8 rectangular or square with more or less rounded edges.

28. The abutment as claimed in claim 1, wherein an outer form of the base is straight, convex, concave, parallel, diverging, converging to the soft tissue.

29. The abutment as claimed in claim 1, wherein an outer abutment surface in the area of the body corresponds to the typical curvature characteristics of teeth.

30. The abutment as claimed in claim 1, wherein the abutment is provided with an elastic or flexible anatomically individual or stylized composite layer or tooth-colored layer, enabling the provisional replacement of a crown that can be burdened immediately.

31. The abutment as claimed in claim 1, wherein there is a distance of 0.2 to 6 mm from the a garland-shaped stage and a garland-shaped base bond surface to the implant.

32. The abutment as claimed in claim 1, wherein the cap is part of a cap set, which includes at least the following caps:

| | | Mesio- | |
|---|---|---|---|
| | | distal diameter | Labio-buccal-oral |
| Tooth | Cap length | at stage 12 | diameter at stage 12 |
| Upper jaw | | | |
| Middle incisor | 10.5-5.5 | 7.0-4.0 | 6.0-3.0 |
| Side incisor | 9.5-4.5 | 5-2.0 | 5.0-2.0 |
| Canine | 10.0-5.0 | 5.5-2.5 | 7.0-4 |
| First premolar | 8.5-3.5 | 5.0-2.0 | 8.0-4.0 |
| Second premolar | 8.5-3.5 | 5.0-2.0 | 8.0-4.0 |
| First molar | 7.5-2.5 | 8.0-5.0 | 10.0-6.0 |
| Second molar | 7.0-2.5 | 7.0-4.0 | 10.0-4.0 |
| Third molar | 6.5-2.5 | 6.5-2.5 | 9.5-4.0 |
| Lower jaw | | | |
| Middle incisor | 9.0-4.0 | 3.5-2.0 | 5.3-2.3 |
| Side incisor | 9.5-4.5 | 4.0-2.0 | 5.8-2.8 |
| Canine | 11.0-6.0 | 5.5-2.5 | 7.0-4.0 |
| First premolar | 8.0-3.5 | 5.0-2.0 | 6.5-3.5 |
| Second premolar | 8.5-3.0 | 5.0-2.0 | 7.5-4.0 |
| First molar | 7.0-2.5 | 9.0-6.0 | 9.0-5.0 |
| Second molar | 7.0-2.0 | 8.0-5.0 | 9.0-5.0 |
| Third molar | 7.0-2.5 | 7.5-4.5 | 9.0-5.0 |

33. A tooth implant with a root section or shaft that can be anchored in a jaw by being screwed in and with an abutment that can be fixed by an adhesive bond on a coronal area of the shaft the abutment is by claim 1.

34. A process for manufacturing a dental prosthesis using an abutment wherein an abutment corresponding to the form of the tooth to be reconstructed is selected from the abutment set and that this abutment is then prepared and provided with a further structure.

35. The process as claimed in claim 34, a shell forming the outer surface of the crown is applied, to the abutment forming the base of a crown.

36. The process as claimed in, claim 34, further comprising an additional, separately manufactured structure is fixed to the abutment after preparation.

37. The process as claimed in claim 34, wherein the abutment is manufactured individually corresponding to a tooth to be reconstructed.
